(19) United States
(12) Patent Application Publication
(10) Pub. No.: US 2010/0209898 A1
(43) Pub. Date: Aug. 19, 2010

(54) Toilet training device

(76) Inventor: Joseph R. Ward, Slidell, LA (US)

Correspondence Address: KEATY LAW FIRM, LLC, 365 CANAL STREET, Suite 2410, NEW ORLEANS, LA, 70130, US

(21) Appl. No.: 12/378,651

(22) Filed: Feb. 18, 2009

(51) Int. Cl. G09B 19/00

(52) U.S. Cl. 434/247

(57) ABSTRACT

A toilet-training device to be secured on an article of clothing worn by a child has an input member with a recorder for recording a caregiver's audio message to the child, a timer, speaker for playing the recorded message, a processor/controller in data communication with the timer, the recorder and the speaker. The processor/controller is programmable for actuating the speaker and/or vibrator at predetermined time intervals so as to remind the child to use a toilet.

### BACKGROUND OF THE INVENTION

The present invention relates generally to infant teaching devices, and, more specifically, to a toilet training device. The device is used to remind a child or toddler of a need to use a toilet before the infant soils a diaper.

Today, disposable articles, such as diapers, are widely used in infant and toddler care as a means of containing, isolating and disposing of bodily wastes. These articles have generally replaced reusable, washable cloth garments as the preferred means for these applications because of their convenience and reliability. An infant or toddler is inadvertently encouraged to continue to use the disposable diapers for longer periods of time as the manufacturers have increased liquid-absorbing properties of the child diapers. Such usage only promotes and encourages child to continue to “potty in pants” with little discomfort to the wearer. However, the accumulation of waste held close to the child's body, for hours on end, results frequently in many dermatitis issues, infection, including bladders, etc.

The ever-increasing sizes of the diapers geared to older children perpetuate the desire of caregivers to continue using the disposable undergarments even as the child grows. All this prolongs the potty training process both in the minds of the child and the caregivers. The convenience is not without a cost—direct cost to the caregiver, as well as the cost of pollution in large landfills. The environmental impact is obvious as millions and millions of children use disposable diapers that remain unsanitary untreated waste in the landfills. According to some estimates, 27 billion disposable diapers are dumped into landfills annually.

The present invention contemplates provision of a child training device that reminds the child to use a sanitary toilet before the child has an opportunity to soil the diaper.

### SUMMARY OF THE INVENTION

It is, therefore, an object of the present invention to provide a device for training children in using toilet facilities instead of a disposable diaper.

It is another object of the invention to provide a device that can be worn by a child with an article of clothing.

It is a further object of the invention to provide a programmable alert device that reminds a child of the time for using the toilet facility at pre-selected intervals.

These and other objects of the invention are achieved through a provision of A toilet-training device to be secured on an article of clothing worn by a child has an input member with a recorder for recording a caregiver's audio message to the child, a timer, speaker for playing the recorded message, a processor/controller in data communication with the timer, the recorder and the speaker. The processor/controller is programmable for actuating the speaker and/or vibrator at predetermined time intervals so as to remind the child to use a toilet instead of a diaper.

The processor/controller can be a system-on-chip device, and the input can be made through one or more capacitive sensors.

### BRIEF DESCRIPTION OF THE DRAWINGS

Reference will now be made to the drawings, wherein like parts are designated by like numerals, and wherein

FIG. 1 is a plan view of the training device according to the present invention.

FIG. 2 is a schematic view of the device of the present invention showing the electronic/electrical components of the device. The top cover is removed for clarity.

FIG. 3 is a perspective view of an exemplary article of clothing to be worn by a child, with the device of the present invention secured thereon.

FIG. 4 is a detail view showing the attachment tabs on the waist belt, with the device of the instant invention secured to the belt.

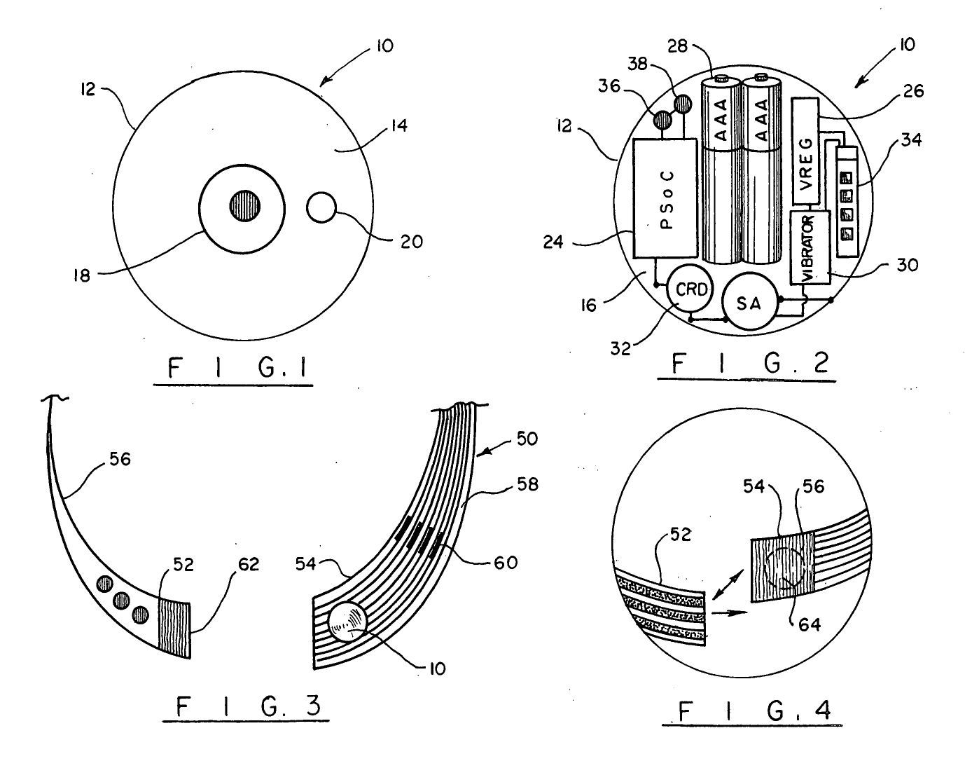

### DETAIL DESCRIPTION OF THE INVENTION

Turning now to the drawings in more detail, numeral 10 designates the training device according to the present invention. The device 10 comprises a housing 12 having a top cover 14, which together with a base plate 16, encloses electric/electronic components of the device. Mounted to the top cover 14 is a sound emitting device, such as speaker/amplifier 18 that delivers a pre-recorded audio message at selected intervals. An optional on/off speaker switch 20 is accessible from the top cover 14. The speaker switch 20 can be selectively activated by a caregiver to allow the recorded audio message to be audible by the child.

As shown in FIG. 2, the device 10 comprises an integrated circuit, for instance a programmable system-on-chip 24 mounted on the base plate 16. The chip 24 can be programmed to deliver audio messages that have been pre-recorded by the caregiver. The messages remind the child, in caregiver's voice, that it is time for the child to use the toilet. The messages can be delivered at timed intervals, for instance every 1-2 hours, at times the caregiver expects the child to be in need of a toilet. If the child takes a nap during the day, the on/off switch 20 can be pressed to mute the speaker so as not to disturb the child during rest.

The chip 24 is basically a controller/processor; it includes one or more memory blocks and a timing source in the form of an oscillator and/or phase-locked loops. The chip 24 may also contain a counter-timer, real-time timer and power-on reset generators. If desired, the chip 24 may also include an external interface, such as a USB cable connection to allow the caregiver to connect the device 10 to a computer for programming the device 10, for changing the message and for other functions that can be programmed into the processor of the chip 24. The processor embedded into the system-on-chip 24 is capable of running software such as Windows or Linux. Other optional features of the chip 24 may include an analog interface, including ADCs and DACs. The chip 24 is operationally connected to a voltage regulator 26 and a power source 28. The power source may be a battery pack consisting of one or more AAA batteries. Of course, other power options may be used if desired. The voltage regulator 26 automatically maintains a constant voltage level during operation of the device 10. The electronic voltage regulator 26 compares the actual output voltage to the internal fixed reference voltage set by the microcontroller in the chip 24. Any difference is amplified and used to control the elements of the device 10 electronic circuitry.

A vibrator 30 is mounted on the base 16 to provide vibration to the device 10 instead or in addition to, the audio signal generated by the speaker 18. The vibrator 30 is operationally connected to a recording device 32 and to the processor/controller of the chip 24.

A block of functional devices 34 is provided on the base 16 in operational connection to the processor/controller 24. The interface devices 34 may be capacitive sensing devices or mechanical buttons. In one of the preferred embodiments, capacitive sensors, or proximity-based sensors are used. Generally, the capacity sensors include two electrodes, which are covered by an insulating stratum—plastic or glass—and, when a finger touches the surface, a capacitance is created. This change in capacitance then triggers the execution of a pre-programmed function. The process relies on proximity based sensing, where the maximum sensible proximity is set to the thickness of the stratum overlay and does not strictly require physical contact of the user with the devices 34. The benefit of using capacitive sensing device is that it provides a control mechanism not subject to dirt, dust, wear, moisture, and other factors that can affect the life of other control interface devices incorporated into the device 10.

The chip 24 takes its input from the capacitive sensors 34. The capacity sensors 34 provide programmable sensing via assembly or language coding. The current technology allows for the capacity sensor to support up to twenty-one general purpose I/Os for buttons, multi-segment sliders, proximity detection, touchpads, LEDs, and other general purpose functions.

A controller/processor on/off switch 36 is provided in the circuitry of the device 10 to allow the caregiver to selectively activate the device 10 when necessary and to turn it off when the child is resting or the device 10 is not in use. A light indicator 38, which can be a light emitting diode, is operationally connected to the switch 36 to provide visual signal on the operational status of the device 10.

The device 10 can be secured on a child's torso by an optional waistband 50. The waistband 50 may be formed from a flexible, stretchable elastic material that easily adapts to the size of the child's waist without constricting the child's movements. The waistband forms an open loop with opposing ends 52 and 54. A pocket 56 is formed in the end 54 for housing the device 10. The pocket 10 is sized and configured to accommodate the housing 12, while retaining the device 10 in close proximity to the child's body.

The interior surface 56 of the waistband 50 can be covered with soft material so as not to cause skin irritation of the child. The exterior surface 58 of the waistband 50 can be provided with various designs 60, color drawings and the like.

A securing piece of hook-and-loop fasteners 62 is secured on the inner surface 56 of the end 52. A matching securing piece of hook-an-loop fasteners 64 covers the pocket 56 on the exterior surface of the end 54. When the securing strips 62 and 64 are engaged together, the waistband 50 forms a closed loop, this securing the device 10 on the child's body.

In operation, a caregiver has an option of selecting one of the factory default settings for the operation of the device 10 or program the device 10 via the controller/processor 24. In both cases, the device 10 provides an option for the caregiver to record a personal message of directions and encouragement for the child during the toilet training process. The audio recording component allows the user to selectively record a message in an audio clip to be played at pre-set intervals.

Once the necessary functions of the device have been programmed to the caregiver's satisfaction, the device 10 can be placed in the pocket 56, and the waistband 50 secured on the child's body. The child can wear the waistband 50 during walking hours, while the device 10 prompts the child to use the toilet at set intervals.

As the child grows older, the intervals between the toilet uses can be increased. It is envisioned that the use of the device 10 can substantially shorten the time required to toilet-train an infant. As a consequence, fewer diapers will be used, saving costs to the caregiver and reducing an environmental impact by thousands of disposable diapers.

Many changes and modifications can be made in the design of the present invention without departing from the spirit thereof. I therefore pray that my rights to the present invention be limited only by the scope of the appended claims.

I claim:

1. A toilet-training device to be fitted to a wearer comprising:
a recording means for recording a caregiver's audio message to the wearer;
a timer;
a sound-emitting means for playing the recorded message; and
a processor/controller in data communication with said timer, said recording means and said speaker means, said processor/controller having programming for actuating the sound-emitting means at predetermined time events.

2. The device of claim 1, further comprising a vibrating member for providing a vibrating signal to the wearer at predetermined time events, said vibrating member being in operational communication with the processor/controller.

3. The device of claim 1, wherein said pre-set time events are time intervals.

4. The device of claim 1, further comprising an input device for selecting said predetermined time event.

5. The device of claim 4, wherein said input device is a capacitive sensing member.

6. The device of claim 1, further comprising an on/off switch for selectively activating and de-activating the sound-emitting means.

7. The device of claim 6, further comprising a light emitter being electrically coupled to the processor/controller and a processor/controller on-off switch coupled to the processor/controller, said light emitter emitting light when said processor/controller is activated.

8. The device of claim 1, wherein said processor/controller is a system-on-chip device.

9. The device of claim 1, further comprising a housing for housing said processor/controller, said recording means, said timer and said sound-emitting means.

10. The device of claim 9, wherein said housing is sized and configured to be positioned in an article of clothing fitted to the wearer.

11. The device of claim 10, wherein said article of clothing is a waistband with a pocket for receiving the housing therein.

12. The device of claim 11, wherein said waistband is adjustably securable on the wearer's waist.

13. The device of claim 9, further comprising an independent power source positioned in said housing.

14. A toilet-training device to be secured on an article of clothing worn by a child, the device comprising:
a recording means for recording a caregiver's audio message to the child;
a timer;
a sound-emitting means for playing the recorded message;
a processor/controller in data communication with said timer, said recording means and said speaker means, said processor/controller having programming for actuating the sound-emitting means at predetermined time intervals; and
a vibrating member for providing a vibrating signal to the child at predetermined time intervals, said vibrating member being in operational communication with the processor/controller.

15. The device of claims 14, further comprising an input device for selecting said predetermined time intervals.

16. The device of claim 15, wherein said input device is a capacitive sensing member.

17. The device of claim 14, wherein said processor/controller is a system-on-chip device.

18. The device of claim 14, further comprising an on/off switch for selectively activating and de-activating the sound-emitting means.

19. The device of claim 18, further comprising a light emitter being electrically coupled to the processor/controller and a processor/controller on-off switch coupled to the processor/controller, said light emitter emitting light when said processor/controller is activated.

20. The device of claim 14, further comprising an independent power source.

21. The device of claim 20, further comprising a housing for housing said power source, said processor/controller, said recording means, said timer, said sound-emitting means, and said vibrating means.

22. The device of claim 21, wherein said housing is sized and configured to be positioned on an article of clothing fitted to the child.

23. The device of claim 22, wherein said article of clothing is a waistband with a pocket for receiving the housing therein.

24. The device of claim 23, wherein said waistband is adjustably securable on the child's waist.
